(19) United States
(12) Patent Application Publication
(10) Pub. No.: US 2019/0001882 A1
(43) Pub. Date: Jan. 3, 2019

(54) Pregnancy Light

(71) Applicant: Brian Kennedy, Tuskegee, AL (US)

(72) Inventor: Brian Kennedy, Tuskegee, AL (US)

(21) Appl. No.: 15/468,638

(22) Filed: Mar. 24, 2017

Related U.S. Application Data
(60) Provisional application No. 62/314,161, filed on Mar. 28, 2016.

(51) Int. Cl. B60Q 7/00; B60Q 1/52; B60Q 1/26

(52) U.S. Cl. CPC B60Q 7/00; B60Q 1/2696; B60Q 1/52

(57) ABSTRACT

A pregnancy light includes a magnetic base, a base plate, a plurality of light emitting diode (LED) lights, a control system, and an outer covering. The base plate is fixedly attached to the magnetic base. The plurality of LED lights are mounted around a periphery of the base plate. The control system is coupled to the plurality of LED lights and operable to independently and collectively produce a rotating light pattern. The magnetic base may also be equipped with suctions that can securely allow the pregnancy light to remain fixed on the surface of a motorized vehicle, in tandem with the magnetic ring attached to the base. Additionally, the covering for the magnetic base may be made of a rubber-like material to prevent movement of the pregnancy light while situated on a moving vehicle.

This application claims priority to U.S. Provisional Application Ser. No. 62/314,161 filed on Mar. 28, 2016 and titled “Preggo Light”, the entire contents of which are hereby incorporated by reference.

### BACKGROUND OF INVENTION

This invention relates to emergency lights, and more particularly to emergency lights that are attachable to motorized vehicles to assist expectant mothers en route to the hospital by alerting other motorists in the area of the emergency situation.

The most common emergency lights for personal vehicles are built-in in the form of hazard lights. These lights reflect off both ends of a vehicle, and allow a driver to alert other people in proximity that them is an issue or to proceed with caution. Common issues are, but are not limited to: having a flat tire, engine trouble, weather conditions, and other emergency situations.

Additionally, motorized vehicles for law enforcement and medical personnel are equipped with more intense lighting. Commonly seen are the blue/red LED light combination on law enforcement vehicles to alert everyone in the vicinity of their presence. Other motorists know to pull over or to move driving lanes in order to let the law enforcement vehicles pass. The same concept is seen in medical ambulances utilizing a red/white LED combination.

A problem arises for people who are expecting a child and need to go from one location, such as their residence, to the hospital. This is especially true in cases of emergency, where the driver may need to exceed traditional speed limits in order to reach a medical facility in time. Unfortunately, as mentioned above, hazard lights serve a large spectrum of purposes, and drivers use them for so many varying reasons that they are not as highly respected as law enforcement or medical vehicles.

Furthermore, utilizing an ambulance for the benefit of getting to a hospital faster and with less traffic is quite costly, and many people cannot afford it. Currently, there is no manufacture or device that can effectively alert nearby motorists that an expectant mother is en route to a hospital.

U.S. Pat. No. 2014/0085072A1 to Checkers Industrial Products discloses a LED strobe light that consists of a base, a mounting post, a plurality of LED lights, a control system, and a lens. The disadvantage of this invention is that it is not equipped with a means to remain attachable to a moving vehicle without permanently attaching to it. The present invention has the means to allow temporary attachment for convenience and is also equipped with a means for Global Positioning System (GPS) that can allow medical facilities to track incoming patients. Additionally, the present invention may be coupled with a mobile application usable through most smart phones that can allow relatives and friends track various movements and receive messages and graphics from the user.

### SUMMARY OF INVENTION

It has been recognized that it would be desirable to provide an emergency light that provides a higher alert than hazard lights for motorists transporting a pregnant woman to a hospital without having to use an expensive alternative, such as an ambulance.

According to one aspect of the present invention, a pregnancy light, which includes a base, a means for emitting light, and an outer covering, and a magnetic base can be implemented to easily attach to any motorized vehicle and perform the function of alerting nearby motorists that a pregnant woman is en route to a hospital.

In some embodiments, the pregnancy light is provided having a base, a battery-powered light source, an outer covering, and a magnetic base. The base is easily attached to the top of a motorized vehicle utilizing a magnet. The outer covering is made out of a durable material, preferably a tough plastic, or a strong polymer, one that can withstand any incidental contact with debris while driving at high speeds. Furthermore, the pregnancy light manufacture will have a low center of gravity in order to avoid the device detaching off an automobile driving at high speeds. The magnetic connection shall be strong enough to withstand the wind and wind resistance created by driving at high speeds.

In some embodiments, the pregnancy light is provided having a base, a battery powered light source, an outer covering, and a magnetic base. The base is easily attached to the top of a motorized vehicle utilizing a suction-mechanism. A fastener can also be added as a means for further attachment. The outer covering is made out of a durable material, one that tan withstand the wind and wind resistance created by driving at high speeds.

In some embodiments, the covering for the pregnancy light is a pink color that can be easily visible e and distinguishable in both day and night conditions. By utilizing a color not currently; seen on any motorized vehicles, it would be easy for any motorist, once aware of its existence, to switch lanes in order for that vehicle to easily pass. Additionally, local law enforcement can also provide an escort to a hospital knowing that that particular vehicle is carrying a pregnant woman who is en route to a hospital facility.

In some embodiments, the bottom of the base may be fitted with a material that prevents sliding, such as a type of rubber, that can supplement the magnets in ensuring the device does not slide off of a vehicle at higher speeds.

In some embodiments, the pregnancy strobe light may be equipped with a means for Global Positioning System (GPS). This could allow medical facilities to track the movement of a incoming patient.

In some embodiments, the pregnancy strobe light may be connected to a mobile application that cal perform a similar function to the UPS stated above, but also allow family members and friends to follow the route through their cellular devices and can also receive notifications signaling a departure, arrival, and other messages.

These and other objects, features, and benefits of the present invention will become more apparent upon reading the following specifications in tandem with the attached drawings and figures.

These objects are achieved by having a pregnancy light that is easily attachable to any motorized vehicle through a magnetic base and at least one suction mechanism. The pregnancy light in one embodiment is equipped with the ability to be battery-powered to power a plurality of lights. Additionally, the pregnancy light may be paired with a mobile application that allows communication between different users, including, but not limited to, medical facilities, family members, and friends. Furthermore, the pregnancy light can be fabricated utilizing a means for Global Positioning System (GPS) in order to track individual pregnancy lights. This feature can be utilized with any motorized vehicle and can also be applied to driverless cars.

### BRIEF DESCRIPTION OF THE DRAWINGS

FIG. 1 is a perspective view of one embodiment of the pregnancy light of this invention.

FIG. 2 is a perspective view of one embodiment of the pregnancy light of this invention with the outer covering removed.

FIG. 3 is an exploded view of one embodiment of the pregnancy light of this invention.

FIG. 4 is an upside-down exploded view of one embodiment of the base of this invention.

FIG. 5 is an upside-down view of one embodiment of the base of this invention.

FIG. 6 is a perspective view of one embodiment of the base of this invention.

### DETAILED DESCRIPTION OF THE INVENTION

It is to be understood that the following disclosure provides different embodiments, or examples, for implementing different features of various embodiments of the invention. Specific examples of components and arrangements are described below. These are merely examples and arm not intended to be limiting. In addition, the present disclosure may repeat reference numerals and/or letters in the various examples. This repetition is for the purpose of simplicity. Hereinafter, an exemplary embodiment of the present disclosure will be discussed in reference to the drawings.

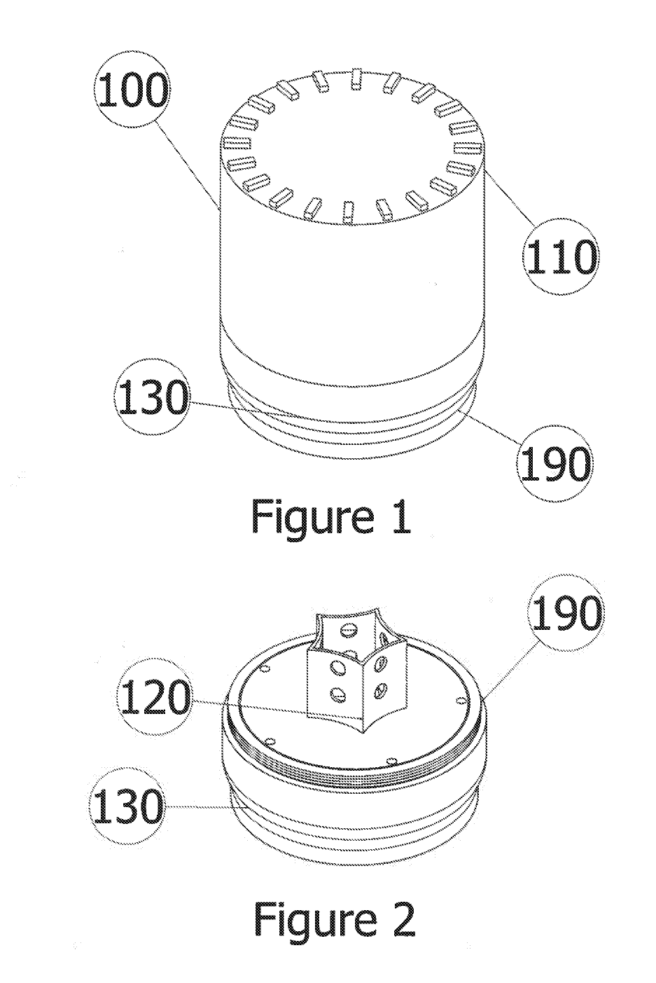

The pregnancy light 100 of this invention is illustrated in FIG. 1. Outer covering 110 is attached to base 130. Outer covering 110 is preferably made out of hard material, preferably plastic, or a strong polymer, one that can withstand incidental debris while driving at high speeds. Outer covering 116 is preferably transparent, and tinted a pink color in order to visibly show a pink light to other vehicles and bystanders. Base 130 is the support for the lighting mechanism and also contains the power source. The outer edges of the top of base 130 in one embodiment has grooves 190 that allow the outer covering 110 to screw into base 130. This allows easy interaction with the device if maintenance if ever needed.

FIG. 2 depicts base 130 with outer covering 110 removed. Light fixture 120 is an apparatus for housing at least one light emitting diode (LED) light. A plurality of LED lights are able to be fixedly attached through light fixture 120. In one embodiment, light fixture 120 can hold up to ten LED lights that can be programmed to display in a sequenced manner that gives the illusion of a strobe function utilizing a controller 300 capable of being programmed for various light displays and sequences. Controller 300 is visible in FIG. 6.

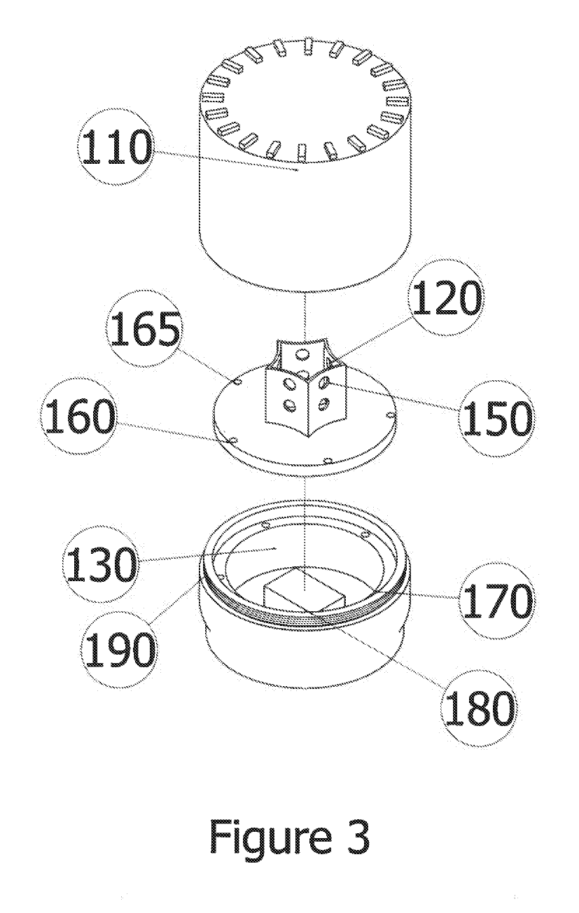

FIG. 3. shows an exploded view of the assembly of pregnancy light 100 to give a better understanding of its configuration. Bottom base 130 contains battery compartment 180. Bottom base 130 is equipped with grooves 190 that allow it to connect to outer covering 110. Additionally, bottom base 130 has screw insert bottom 170 that allows base plate 160 to be screwed in through screw insert top 165. Base plate 160 is the platform that supports light fixture 120.

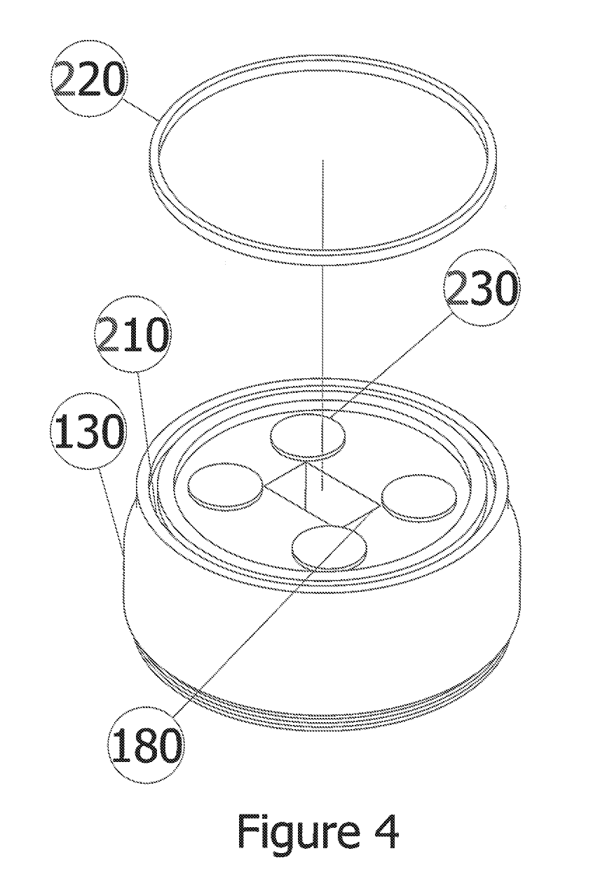

FIG. 4 depicts an upside-down exploded view of base 130. Base 130 is fitted with a magnetic ring 220. Magnetic ring 220 will allow the pregnancy light 100 the capability to be attached to any surface of a motorized vehicle, preferably the top. Additionally, base 130 is equipped with at least one suction mechanism 230. Suction mechanism 230 will give added support to magnetic ring 220 by created additional force that will allow pregnancy light 100 to stay in a fixed position on a motorized vehicle, especially when moving at higher speeds. Through this angle, battery compartment 180 is accessible in order to change or install a battery to power pregnancy light 100.

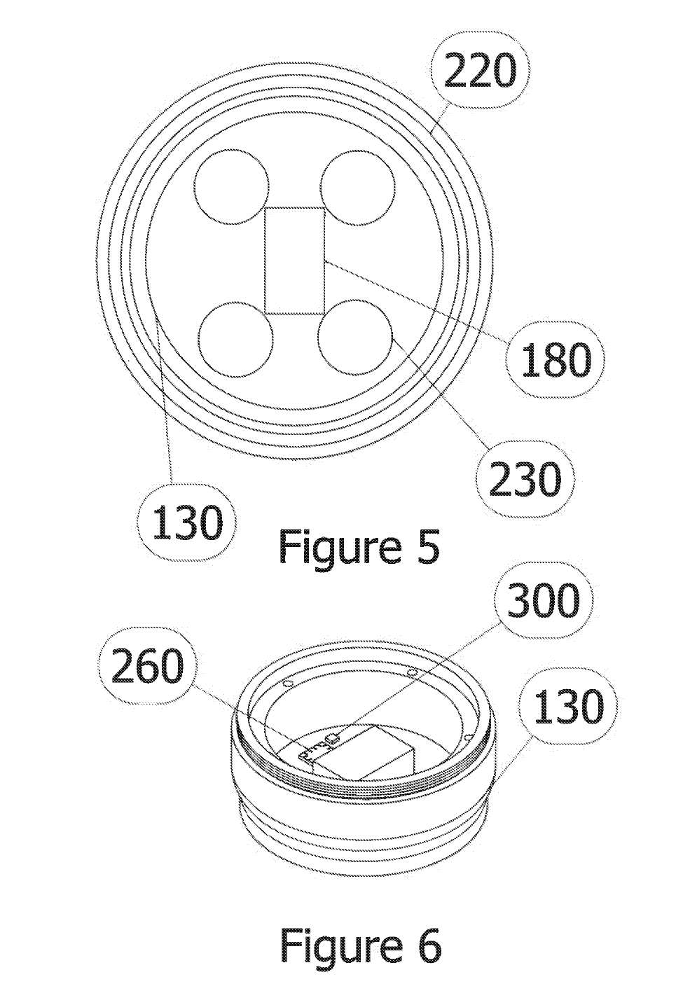

FIG. 5 is a two-dimensional view of the bottom of base 130 to give a clear representation of its configuration. Magnetic ring 220 fits into base 130 on the outer edge of the surface. In a preferred method of use, a user can take pregnancy light 100 and attach it to the top of their vehicle. By pressing down, and activating suction mechanism 230, the pregnancy light 100 will stick to the surface of their vehicle, along with having a magnetic seal provided by magnetic ring 220.

FIG. 6 shows a perspective view of one embodiment of base 130. In one embodiment, base 130 is equipped with a means for Global Positioning System (“OPS”). This will allow pregnancy light 100 to be trackable in a multitude of ways. In one embodiment, this will allow pregnancy light 100's location to be viewable by medical facilities. In another embodiment, this will allow pregnancy light 100 to be paired with a mobile application. In this mobile application, the pregnancy light 100's location will be viewable to other selected users, such as family and friends. Giving birth is a very special time for many families, and it is hard in the moment to be able to convey certain things to family and friends. By pairing pregnancy light 100 with a mobile application, family and friends can monitor departures and arrivals to medical facilities and receive other messages and graphics concerning the pregnancy.

### BEST MODE OF THE INVENTION

In the preferred embodiment of pregnancy light 100, referring to the exploded view of FIG. 3, the outer covering 110 should be made of a hard, durable polymer or plastic, one that can withstand incidental debris while driving at high speeds. It is preferable the entire pregnancy light 100 have a low center of gravity in order to reduce the effect of the wind driving at high speeds. Light fixture 120 is preferred to hold up to ten small lights, where, through the use of controller 300, can be programmed to give off a sequenced light pattern that makes it appear to be flashing. Light fixture 120 should be made out of a metallic material as to not be impacted from any heat generated from the plurality of lights. Additionally, base 130 may be covered with a rubber-like material that will reduce the tendency of pregnancy light 100 to shift its position while attached to the top of a moving vehicle. Between a rubber-like material on the bottom of base 130, suction mechanism 230, and the magnetic ring 220, pregnancy light 100 shall be able to be attached and remain static on top of a moving vehicle.

What is claimed is:

1. A pregnancy light that is attachable to a motorized vehicle that can alert nearby motorists and pedestrians, comprising:
a magnetic base;
a base plate fixedly attached to the base;
a plurality of light emitting diode (LED) lights mounted around a periphery of the base plate;
a control system coupled to the plurality of LED lights and operable to independently or collectively produce a rotating light pattern;
an outer covering.

2. The pregnancy light of claim 1, wherein the base has at least one suction cup fixedly attached to it.

3. The pregnancy light of claim 1, wherein the base is equipped with a means for Global Positioning System (OPS).

4. The pregnancy light of claim 1, wherein the bottom surface of the base is made of a rubber-like material.

5. The pregnancy light of claim 1, wherein the outer covering is transparent.

6. The pregnancy light of claim 1, wherein the pregnancy light is coupled to a mobile phone application in order to allow real-time location to designated uses.

7. The pregnancy light of claim 1, wherein the LED lights are pink.

8. The pregnancy light of claim 2, wherein the base is equipped with a means for Global Positioning System (OPS).

9. The pregnancy light of claim 2, wherein the bottom surface of the base is made of a rubber-like material.

10. The pregnancy light of claim 2, wherein the outer covering is transparent.

11. The pregnancy light of claim 2, wherein the pregnancy light is coupled to a mobile phone application in order to allow real-time location to designated users.

12. The pregnancy light of claim 2, wherein the LED lights are pink.

13. The method of using a pregnancy light to alert nearby motorists and pedestrians, comprising:
turning the pregnancy light on;
attaching the pregnancy light to a surface of a vehicle;
driving said vehicle to a medical facility.

14. The method of claim 7, wherein the pregnancy light alerts a designated medical facility of an incoming patient.
